(19) United States
(12) Patent Application Publication
(10) Pub. No.: US 2018/0052651 A1
(43) Pub. Date: Feb. 22, 2018

(54) DISPLAY APPARATUS, VIDEO WALL SYSTEM HAVING THE SAME AND CONTROL METHOD THEREOF

(71) Applicant: SAMSUNG ELECTRONICS CO., LTD., Suwon-si (KR)

(72) Inventors: Ho-yong SON, Hwaseong-si (KR); Hong-jae KIM, Suwon-si (KR)

(21) Appl. No.: 15/672,658

(22) Filed: Aug. 9, 2017

(30) Foreign Application Priority Data
Aug. 19, 2016 (KR) 10-2016-0105813

(51) Int. Cl. G06F 3/14; G09F 9/302

(52) U.S. Cl. CPC G06F 3/1446; G09G 2300/026; G09F 9/3026

(57) ABSTRACT

A video wall system is provided. The video wall system includes a first display apparatus and a second display apparatus. The first display apparatus displays a first individual image which corresponds to a first area of a first video wall image, and transmits the first video wall image to the second display apparatus; and, in response to an execution condition for anti-screen burn operation being satisfied while the first individual image is displayed, generates a second video wall image by changing the first video wall image, displays a second individual image which corresponds to the first area of the generated second video wall image, and transmits the generated second video wall image to the second display apparatus. The second display apparatus displays a third individual image which corresponds to a second area of one video wall image of the first video wall image and the second video wall image received from the first display apparatus, wherein the second area is different from the first area.

### CROSS-REFERENCE TO RELATED APPLICATION

This application is based on and claims priority under 35 U.S.C. §119 to Korean Patent Application No. 10-2016-0105813, filed on Aug. 19, 2016 in the Korean Intellectual Property Office, the disclosure of which is incorporated by reference herein in its entirety.

### BACKGROUND

### Field

The present disclosure relates generally to a display apparatus, a video wall system having the same and a control method thereof, and for example, to a display apparatus, a video wall system having the same and a control method thereof, which prevent and/or reduce a screen burn.

### Description of Related Art

A display apparatus, which displays an image using a luminescence phenomenon according to an excitation of phosphors, or light-emitting pixels, like a cathode ray tube (CRT), an organic light emitting diodes (OLED) display panel or a plasma display panel, may lose an image display function due to a screen burn caused by a luminance degradation of the phosphors or the light-emitting pixels if displaying the image in the same luminance for many ours. The screen burn occurs as, for example, a phosphor substance applied on an inner side of the tube is exposed to strong electromagnetic waves for a long time so as not to work as well as it should.

In particular, a large format display (LFD), which is a commercial large display installed and operated for the purpose of public relations and information delivery, is used outdoors for a long time. The LFD is divided into a standalone type including a panel and a video wall type including a number of panels connected with one another.

The LFD is vulnerable to the screen burn than a display for home use due to its use environment. To prevent the screen burn, various methods, such as displaying a screen saver or a rolling bar or shifting the image, which is displaying, by the pixel, is being discussed and proposed. However, there is a problem in that displaying the screen saver or the rolling bar disturbs user's display use.

Shifting the image in pixels may not disturb user's display use. However, there is a problem in that if the LFD is the video wall type, screen artifacts may occur since the displays of the LFD shift the image, separately.

### SUMMARY

Example embodiments address at least the above problems and/or disadvantages and other disadvantages not described above.

The example embodiments may provide a display apparatus, a video wall system having the same and a control method thereof, which can prevent and/or reduce a screen burn while reducing and/or preventing the generation of screen artifacts while displaying a video wall image.

According to an aspect of an example embodiment, a video wall system is provided, including a first display apparatus and a second display apparatus configured to display a video wall image, the first display apparatus being configured to display a first individual image corresponding to a first area of a first video wall image, to transmit the first video wall image to the second display apparatus, to, in response to an execution condition for anti-screen burn operation being satisfied while the first individual image is displayed, change the first video wall image to generate a second video wall image, to display a second individual image corresponding to the first area of the generated second video wall image, and to transmit the generated second video wall image to the second display apparatus, and the second display apparatus being configured to display a third individual image corresponding to a second area of one video wall image received from the first display apparatus from among the first video wall image and the second video wall image, wherein the second area is different from the first area. Accordingly, the video wall system may prevent and/or reduce screen burn while reducing and/or preventing generation of screen artifacts while displaying the video wall image.

The execution condition may be satisfied by at least one of: when a command for executing the anti-screen burn operation is input, when a first critical time elapses after the first video wall image is displayed, and when a second critical time elapses after at least a portion of the first video wall image is displayed in a specific color. With this, various conditions for changing the first video wall image may be provided.

The change of the first video wall image may include at least one of: shifting the first video wall image by a predetermined number of pixels, deleting at least a portion of the first video wall image, inserting a replacement image into at least a portion of the first video wall image, and changing at least a portion of the first video wall image in color. According to this, various example embodiments for changing the first video wall image may be introduced.

Each of the first and the second display apparatuses may include a display panel comprising OLED elements. Thus, the OLED elements vulnerable to the screen burn may efficiently prevent and/or reduce generation of the screen burn.

The first display apparatus may be configured to receive the first video wall image from an external apparatus. Thus, an image source for the first video wall image may be provided.

The system may further include a third display apparatus configured to receive one of the first video wall image and the second video wall image from the first display apparatus. With this, a daisy chain type video wall system may be implemented.

The system may further include a third display apparatus configured to receive the one video wall image received from the first display apparatus from among the first video wall image and the second video wall image, from the second display apparatus. Thus, another example embodiment for implementing the video wall system may be introduced.

The first display apparatus may be configured to, in response to the execution condition for anti-screen burn operation being satisfied while the first individual image is displayed, to transmit, to the second display apparatus, an information indicating that the anti-screen burn operation is applied to the second video wall image.

According to an aspect of another example embodiment, a control method of a video wall system is provided comprising a first display apparatus and a second display apparatus configured to display a video wall image, the method including: displaying, by the first display apparatus, a first individual image corresponding to a first area of a first video wall image; transmitting, by the first display apparatus, the first video wall image to the second display apparatus; and in response to an execution condition for anti-screen burn operation being satisfied while the first individual image is displayed, changing, by the first display apparatus, the first video wall image to generate a second video wall image; displaying, by the first display apparatus, a second individual image corresponding to the first area of the generated second video wall image; transmitting, by the first display apparatus, the generated second video wall image to the second display apparatus; displaying, by the second display apparatus, a third individual image corresponding to a second area of one video wall image received from the first display apparatus from among the first video wall image and the second video wall image, wherein the second area is different from the first area. Accordingly, the video wall system may prevent and/or reduce a screen burn while reducing and/or preventing generation of screen artifacts while displaying the video wall image.

The execution condition may be satisfied by at least one of: when a command for executing the anti-screen burn operation is input, when a first critical time elapses after the first video wall image is displayed, and when a second critical time elapses after at least a portion of the first video wall image is displayed in a specific color. Thus, various conditions for changing the first video wall image may be provided.

The change of the first video wall image may include at least one of: shifting the first video wall image by a predetermined number of pixels, deleting at least a portion of the first video wall image, inserting a replacement image into at least a portion of the first video wall image, and changing at least a portion of the first video wall image in color. With this, various example embodiments for changing the first video wall image may be introduced.

Each of the first and the second display apparatuses may include a display panel comprising OLED elements. Thus, the OLED elements vulnerable to the screen burn may efficiently prevent from generating the screen burn.

The method may further include receiving, by the first display apparatus, the first video wall image from an external apparatus. Thus, an image source for the first video wall image may be provided.

The method may further include receiving, by a third display apparatus, one of the first video wall image and the second video wall image from the first display apparatus, and the video wall system may further include the third display apparatus. With this, a daisy chain type video wall system may be implemented.

The method may further include receiving, by a third display apparatus, the one video wall image received from the first display apparatus from among the first video wall image and the second video wall image, from the second display apparatus, and the video wall system may further include the third display apparatus. Thus, another example embodiment for implementing the video wall system may be introduced.

The method may further include, in response to the execution condition for anti-screen burn operation being satisfied while the first individual image is displayed, transmitting, to the second display apparatus, an information indicating that the anti-screen burn operation is applied to the second video wall image.

According to an aspect of further example embodiment, a display apparatus of a video wall system configured to display a video wall image is provided, including: a signal processor configured to split a first video wall image with respect to a first region to generate a first individual image; a display configured to display the first individual image; a communicator comprising communication circuitry configured to transmit first video wall image to at least one first external display apparatus; and a controller configured to control the signal processor to, in response to an execution condition for anti-screen burn operation being satisfied while the first individual image is displayed, change the first video wall image to generate a second video wall image, and to split the generated second video wall image with respect to the first area to generate a second individual image; and to control the communicator to transmit the generated second video wall image. Accordingly, the video wall system may prevent and/or reduce a screen burn without generating screen artifacts while displaying the video wall image.

The controller of the display apparatus may be further configured, in response to the execution condition for anti-screen burn operation being satisfied while the first individual image is displayed, to transmit, to the second display apparatus, an information indicating that the anti-screen burn operation is applied to the second video wall image.

As described above, according to the example embodiments, there are provided a display apparatus, a video wall system having the same and a control method thereof, which can prevent and/or reduce the screen burn while reducing and/or preventing generation of the screen artifacts while displaying the video wall image.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example video wall system according to an example embodiment;

FIG. 2 is a block diagram illustrating an example display apparatus of the video wall system according to an example embodiment;

FIGS. 3A and 3B are block diagrams illustrating example operations of a signal processor, a communicator and a controller of a first display apparatus according to an example embodiment;

FIG. 4 is a diagram illustrating an example of an operation of the first display apparatus according to an example embodiment;

FIG. 5 is a diagram illustrating an example of an operation of a second display apparatus according to an example embodiment;

FIG. 6 is a diagram illustrating an example of an anti-screen burn operation of the video wall system according to an example embodiment;

FIG. 7 is a diagram illustrating another example of the anti-screen burn operation of the video wall system according to an example embodiment;

FIG. 8 is a diagram illustrating a further example of the anti-screen burn operation of the video wall system according to an example embodiment;

FIG. 9 is a diagram illustrating an example video wall system according to another example embodiment;

FIG. 10 is a diagram illustrating an example video wall system according to further example embodiment; and

FIG. 11 is a flowchart illustrating an example control method of the video wall system according to an example embodiment.

### DETAILED DESCRIPTION

Hereinafter, various example embodiments will be described in detail with reference to accompanying drawings. Elements illustrated in the accompanying drawings are referred to in the following descriptions of the example embodiments and for clarity, like reference numerals or symbols presented in respective drawings denote like elements, which substantially perform the same functions.

In the following description, if terminologies, each of which includes such an ordinal number as ‘first’, ‘second’ and the like, are used, those terminologies are used (unless expressly specified otherwise) merely to describe various elements. The terminologies are only used for the purpose of discriminating one element from other elements. In doing so, the various elements should be non-limited by the corresponding terminologies, respectively. The terminologies used in the following description of various example embodiments are applied for explanation purpose only and not for the purpose of limiting the example embodiments as defined by the appended claims and their equivalents.

The present disclosure described below with reference to the example embodiments may be applied to a video wall system and display apparatuses of the video wall system. As a non-limiting implementation example of the video wall system to which the present disclosure is applied, a large format display (LFD), which is installed inside or outside the building to display an image of the content, will be described by way of illustration. However, the present disclosure is not limited thereto and the video wall system according to the present disclosure may be also implemented as a digital signage or a digital information display (DID).

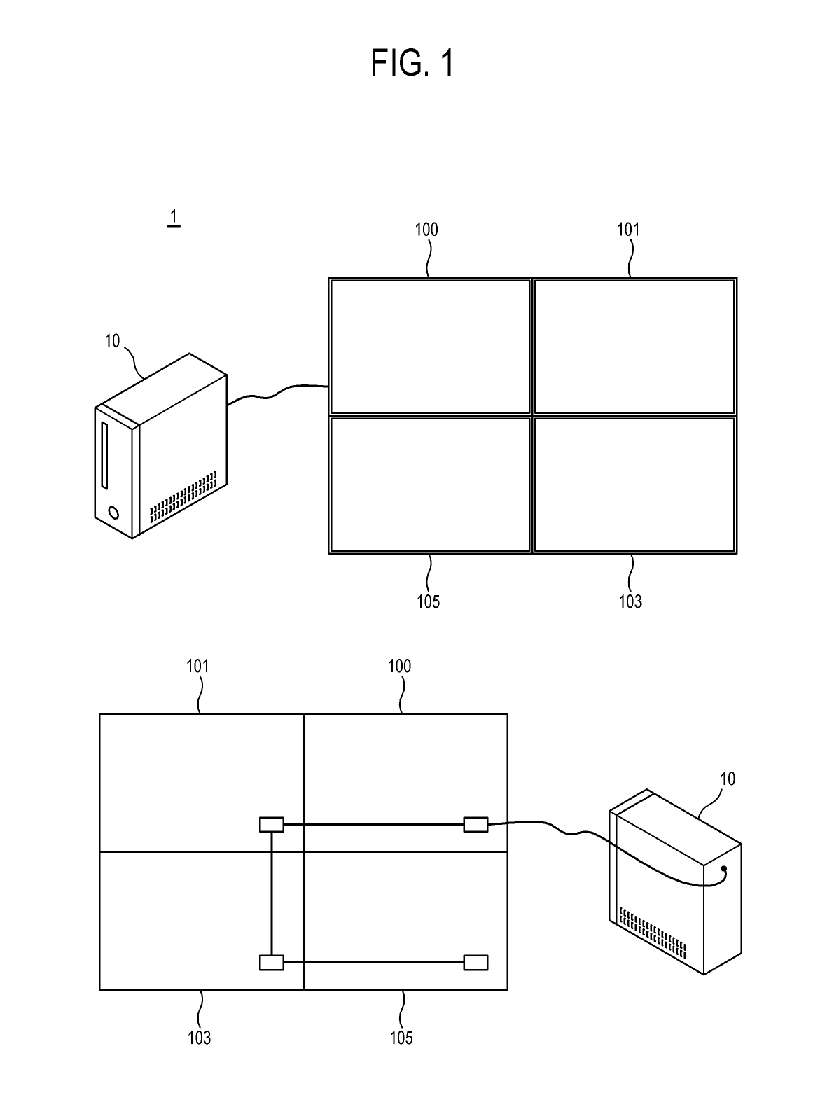

FIG. 1 is a diagram illustrating an example video wall system according to an example embodiment.

The video wall system 1 includes a plurality of display apparatuses 100, 101, 103, and 105. Also, the video wall system 1 may further include an image source 10 to provide an image signal to the display apparatuses 100, 101, 103, and 105.

According to an example embodiment, the plurality of display apparatuses 100, 101, 103, and 105 comprise a video wall. The video wall, which displays one video wall image on the plurality of display apparatuses 100, 101, 103, and 105, may refer, for example, to scaling and displaying the one video wall image to comply with the number and arrangement of the display apparatuses 100, 101, 103, and 105. Each video wall image frame is divided into regions, which correspond to the display apparatuses 100, 101, 103, and 105, respectively and the display apparatuses 100, 101, 103, and 105 displays individual image frames split from each video wall image frame by the divided regions, respectively.

Referring to FIG. 1, as an example, the plurality of display apparatuses of the video wall system 1 may be arranged in a row and column of 2×2. In other words, two display apparatuses are arranged widthwise and two display apparatuses are arranged lengthwise. The plurality of display apparatuses, e.g., first to fourth display apparatuses 100, 101, 103, and 105 arranged in a row and column of 2×2 are arranged at a upper left side, a upper right side, a lower right side, and a lower left side, respectively. Each image frame of the video wall image is divided into regions to correspond to the arrangement method of the display apparatuses 100, 101, 103, and 105, and individual image frames of the divided regions are displayed on the display apparatuses 100, 101, 103, and 105, respectively. However, these are merely illustrations for the convenience of explanation, and the number and arrangement type of the display apparatuses 100, 101, 103, and 105 are not limited thereto. As above, the video wall system 1 displays one video wall image through the plurality of display apparatuses 100, 101, 103, and 105.

Referring to a lower portion of FIG. 1, an example of transmitting the video wall image among the display apparatuses 100, 101, 103, and 105 is illustrated. As an example, each display apparatus 100, 101, 103 or 105 may be daisy-chained with one or two display apparatuses 100, 101, 103, or/and 105 adjacent thereto. Each of the display apparatuses 100, 101, 103, and 105 daisy-chained with one another receives an image signal corresponding to the video wall image, a control signal or the like from the image source 10 or one adjacent display apparatus 100, 101, 103, or 105, and bypasses and transmits the received image signal corresponding to the video wall image to another adjacent display apparatus 100, 101, 103, or 105. Each display apparatus 100, 101, 103, or 105 splits an individual image, which corresponds to a region where it displays, from the video wall image of the image signal input from the one adjacent display apparatuses 100, 101, 103, or 105, and displays the split individual image.

If an execution condition for anti-screen burn operation is satisfied while the video wall image is displayed, the first display apparatus 100 according to an example embodiment changes the video wall image, splits the changed video wall image with respect to an region corresponding to the first display apparatus 100 to generate an individual image therefor, displays the generated individual image, and transmits the changed video wall image to the second display apparatus 101 adjacent thereto. The first display apparatus 100 may further transmit, to the second display apparatus 101, an information indicating that the anti-screen burn operation is applied to the second video wall image.

As a further example embodiment, when transmitting the video wall image to the second display apparatus 101, the first display apparatus 100 may further transmit reference information on screen burn. The reference information includes at least one of: information on whether the execution condition for anti-screen burn operation has been satisfied, information on whether the video wall image has been changed, and information on what kind of change the first display apparatus 100 has performed if the video wall image has been changed.

In an example embodiment, the execution condition for anti-screen burn operation includes at least one of: an input of a command for executing the anti-screen burn operation, an elapse of a predetermined time after the first video wall image is displayed, and an elapse of a predetermined time after at least a portion of the first video wall image is displayed in a specific color. The command for executing the anti-screen burn operation may be input from the image source 10 for providing the image or a user. The video wall system 1 may further include a sensor which can detect whether the predetermined time has elapsed after the at least a portion of the first video wall image is displayed in the specific color.

In an example embodiment, the change of the first video wall image includes at least one of: shifting the video wall image being displayed by a predetermined number of pixels, deleting at least a portion of the video wall image, inserting a replacement image into at least a portion of the video wall image, and changing at least a portion of the video wall image in color. In other words, the first display apparatus 100 changes at least a portion of the video wall image being displayed, and transmits the video wall image, at least a portion of which is changed, to the second display apparatus 101, so that the second to fourth display apparatus 101-105 in turn display individual images of regions corresponding thereto, respectively, among the video wall image, at least a portion of which is changed.

If the changed video wall image is received from the first display apparatus 100, the second display apparatus 101 splits an individual images of a region corresponding thereto from the changed video wall image and displays the split individual images. The second display apparatus 101 also transmits the video wall image, at least a portion of which is changed, to the third display apparatus 103 adjacent thereto.

As another example, the second display apparatus may change the split individual image based on the reference information on screen burn received from the first display apparatus 100 and display the changed individual image, or may not change, but display the split individual image as it is. For example, if the execution condition for anti-screen burn operation is satisfied, the first display apparatus 100 may change the video wall image and transmit the changed video wall image to the second display apparatus 101 along with the reference information on screen burn. The second display apparatus may split an individual image from the changed video wall image based on the reference information on screen burn, and display the split individual image or change the split individual image within the scope that the changed video wall image is not distorted and then display the changed individual image.

As a further example embodiment, if the second display apparatus 101 determines that the execution condition for anti-screen burn operation has been satisfied on its own, the second display apparatus 101 may change the split individual image and display the changed individual image. In other words, the second display apparatus 101 may determine that the first display apparatus 100 did not change the video wall image, based on the reference information on screen burn received from the first display apparatus 100. However, even if the first display apparatus 100 did not change the video wall image, the second display apparatus 101 may determine that the execution condition for anti-screen burn operation has been satisfied. In this example embodiment, the second display apparatus 101 may change the video wall image or the individual image within the scope that the non-changed video wall image is not distorted.

In another example embodiment, the video wall system 1 may display a video wall image based on a broadcasting signal or a content stored in at least one of the plurality of display apparatuses 100, 101, 103 and 105 without a separate image source 10.

As above, the video wall video system 1 according to an example embodiment is configured, so that to perform the anti-screen burn operation, the first display apparatus 100 changes the video wall image being displayed and transmits the changed video wall image to other display apparatuses 101-105 and the other display apparatuses 101-105 display splitting the changed video wall image. Accordingly, the video wall video system 1 may efficiently prevent and/or reduce the screen burn without generating the screen distortion.

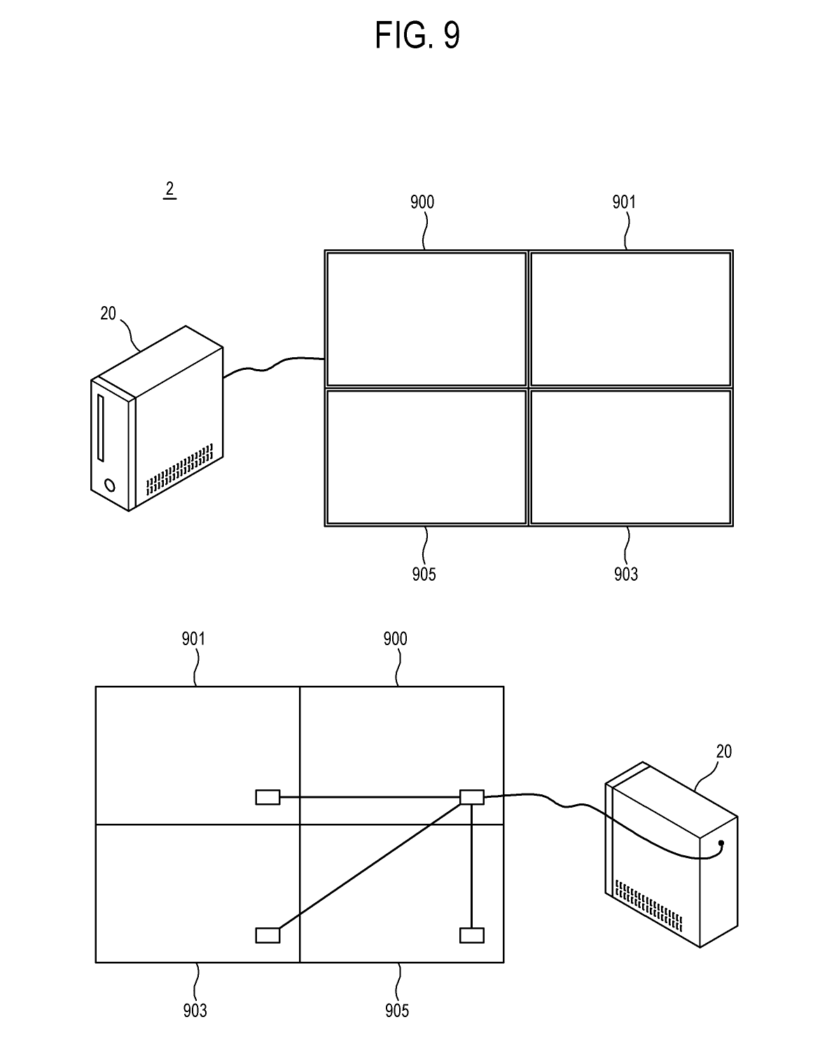

Referring to FIG. 9, as further example embodiment, a video wall system 2 may be connected in a method other than the daisy chain method. For example, the video wall system 2 may be implemented, so that a first display apparatus 900 directly provides a video wall image received from an image source 20 or the like or stored therein to second to fourth display apparatuses 901, 903 and 905. In this example embodiment, if to perform the anti-screen burn operation, the first display apparatus 900 changes the video wall image, the first display apparatus 900 transmits the changed video wall image to the second to fourth display apparatuses 901-905. The second to fourth display apparatuses 901-905 receive the changed video wall image from the first display apparatus 900, split individual images of regions corresponding thereto, respectively, from the received video wall image, and display the split individual images, respectively.

In another example embodiment, the first display apparatus 900 may not change the video wall image, but the individual image split from the video wall image. In this example embodiment, when transmitting the video wall image to the second to fourth display apparatuses 901-905, the first display apparatus 900 may further transmit reference information on screen burn. The second to fourth display apparatus 901-905 may split the video wall image based on the reference information on screen burn transmitted along with the video wall image, and display the split individual images or change the split individual images and then display the changed individual images, respectively. FIG. 9 illustrates an example video wall system 2 in which the first display apparatus 900 is connected to the second to fourth display apparatuses 901-905 as opposed to the daisy-chain arrangement illustrated in FIG. 1.

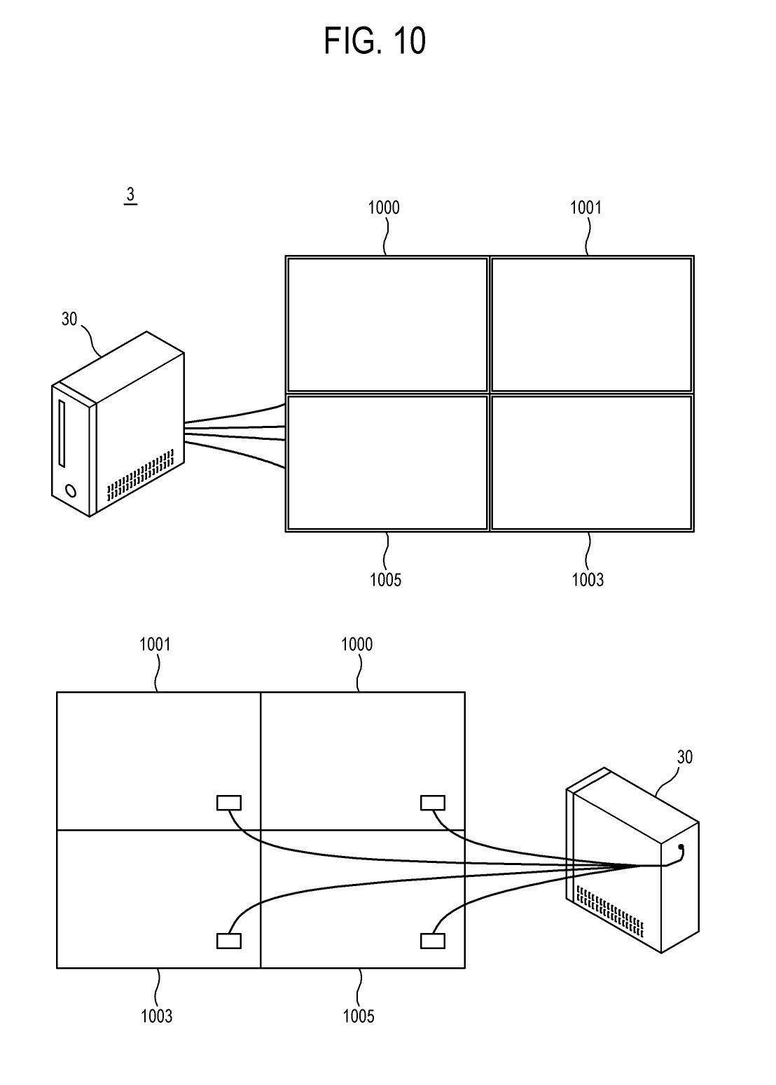

Referring to FIG. 10, as another example embodiment, a video wall system 3 may be implemented, so that an image source 30 provides a video wall image to first to fourth display apparatuses 1000, 1001, 1003, 1005. In the example embodiment, to perform the anti-screen burn operation, the image source 30 changes the video wall image, and transmits the changed video wall image to the first to fourth display apparatuses 1000-1005. The first to fourth display apparatuses 1000-1005 receive the changed video wall image from the image source 30, split individual images of regions corresponding thereto, respectively, from the received video wall image, and display the split individual images, respectively. FIG. 10 illustrates the video wall system 3 in which the image source 30 is connected with the first to fourth display apparatuses 1000-1005, as opposed to the connections illustrated in FIGS. 1 and 9 above.

In another example embodiment, when transmitting the video wall image to the first to fourth display apparatuses 1000-1005, the image source 30 may further transmit reference information on screen burn. The first to fourth display apparatus 1000-1005 may split individual images from the video wall image based on the reference information on screen burn transmitted along with the video wall image, and display the split individual images or change the split individual images and then display the changed individual images, respectively.

Hereinafter, a more detailed example of the first display apparatus 100 of the video wall system according to an example embodiment will be described.

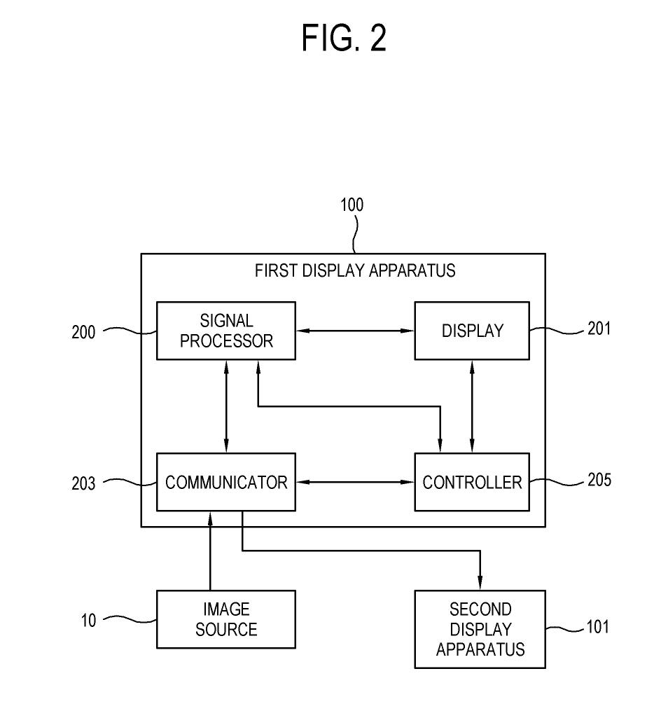

FIG. 2 is a block diagram illustrating an example of the first display apparatus of the video wall system according to an example embodiment. In this example embodiment, if an execution condition for anti-screen burn operation is satisfied, the display apparatus 100 changes a video wall image and transmits the changed video wall image to the second display apparatus 101 adjacent thereto. The first display apparatus 100 may further transmit, to the second display apparatus 101, an information indicating that the anti-screen burn operation is applied to the changed video wall image. The first display apparatus 100 may receive and transmit first the video wall image. The first display apparatus 100 includes a signal processor (e.g., including signal processing circuitry) 200, a display 201, a communicator (e.g., including communication circuitry) 203 and a controller (e.g., including processing circuitry) 205. The first display apparatus 200 may further include at least one of a signal receiver capable of receiving an external signal and a storage capable of storing contents. The configuration of the first display apparatus 100 as illustrated in FIG. 2 is merely an example, and the first display apparatus 100 according to an example embodiment may be also implemented as configurations other than that as illustrated in FIG. 2. In other words, the first display apparatus 100 according to an example embodiment may be implemented as adding elements other than those illustrated in FIG. 2 or removing any one from among elements illustrated in FIG. 2.

The signal receiver (not shown) may include various circuitry that receives an image signal from an outside. The signal receiver may be provided with a tuner for receiving the image signal. The tuner may receive tuning a broadcast signal of any one selected by the user from among a plurality of channels. The signal receiver may also receive an image signal from an image processing apparatus, such as a set-top box, a DVD player, and a PC, a mobile apparatus, such as a smart phone, or a server via an internet.

The storage (not shown) is configured to store various data including image contents of the first display apparatus 100 or the like. The storage 207 may be provided with a non-volatile memory (writable ROM), which retains data regardless of whether the first display apparatus 100 is turned on or off and which is writable to reflect changes. In other words, the storage may be provided with any one of a flash memory, an EPROM and an EEPROM.

The storage may be further provided with a volatile memory, which loses written data if the first display apparatus 100 is turned off. In other words, the storage may be further provided with any one of a DRAM or a SRAM, which is writable and readable and which has a reading or writing speed faster than the non-volatile memory.

The signal processor 200 may include various signal processing circuitry and performs an image processing process with respect to the image signal received via the signal receiver and outputs the processed image signal to the display 201 to display an image on the display 201. The image processing process, which is performed by the various signal processing circuitry of the signal processor 200, may include, for example, a demultiplexing to divide the input transport stream into subordinate streams, which includes an image signal, an audio signal and additional data, respectively, a de-interlacing to convert an interlace type image signal into a progressive type image signal, a scaling to change the image signal in definition, a noise reduction for enhancing image quality, a detail enhancement, a frame refresh rate conversion, or the like, but is not limited thereto.

Also, if an execution condition for anti-screen burn operation is satisfied, the signal processor 200 may change a video wall image based under a control of the controller 205. The change of the video wall image may include at least one of: shifting the video wall image being displayed by a predetermined number of pixels, deleting at least a portion of the video wall image, inserting a replacement image into at least a portion of the video wall image, and changing at least a portion of the video wall image in color.

The signal processor 200 generates an individual image by splitting the video wall image with respect to a region corresponding to the first display apparatus 100, based on a location and a rotation state of the display apparatus 10. After the video wall image is changed, the signal processor 200 splits the changed video wall image with respect to the region corresponding to the first display apparatus 100 to generate the individual image.

According to another example embodiment, any one of the signal receiver and the signal processor 200 may be provided in the image source 10. In another example embodiment, the first display apparatus 100 may receive an image signal received and processed by the image source 10 and display an image based on the received image signal.

The display 201 displays the individual image generated by splitting the video wall image at the signal processor 200. Implemented types of the display 201 are not limited, and the display 201 may be implemented in various display methods, such as liquid crystal display (LCD), plasma display panel (PDP), light-emitting diode (LED) display, organic light emitting diodes (OLED) display, surface-conduction electron-emitter, carbon nano-tube, nano-crystal display, or the like, without limitation.

If the display 201 is a LCD type, the display 201 includes a LCD panel, a backlight unit to supply light to the LCD panel, a panel driving board to drive the LCD panel, etc. The display 201 may be also implemented as an OLED panel, which is a spontaneous emission element, without the backlight unit.

The communicator 203 may include various communication circuitry and is configured to communicate with an external apparatus, such as the image source 10, or a second display apparatus 101 adjacent to the first display apparatus 100 in the video wall system 1. The communicator 203 may be implemented in various types according to implemented types of the image source 10 or the second display apparatus 101. For example, the communicator 203 may include, for example, and without limitation, a connecting part for wired communication. The connecting part may transmit/receive signals/data based on standards, such as high definition multimedia interface (HDMI), HDMI-consumer electronics control (CEC), universal serial bus (USB), a component connector and so on, and include more than at least one connector or terminal corresponding to the standards, respectively. The communicator 203 may communicate by wire with a plurality of servers via a wired local area network (LAN).

According to design methods of the first display apparatus 100, the communicator 203 may include various constructions besides the connecting part including the connector or terminals for wired connection. As an example, the communicator 203 may include various communication circuitry, such as, for example, and without limitation, a radio frequency (RF) circuit for transmitting and receiving a RF signal to perform a wireless communication with the image source 10 and the adjacent second display apparatus 101, and may be configured to perform communication via at least one from among wireless fidelity (Wi-Fi), Bluetooth, Zigbee, ultra-wide band (UWB), wireless USB, and near field communication (NFC).

The controller 205 may include various processing circuitry and performs controls needed for operating all the elements of the first display apparatus 100. The controller 205 may include a control program for controlling to perform the control operation as described above, a non-volatile memory in which the control program is installed, a volatile memory in which at least one of the control program is loaded, and, for example, and without limitation, at least one microprocessor or central processing unit (CPU) for executing the loaded control program. The control program may include a program (or programs) which is implemented in the form of at least one of a BIOS, a device driver, an operating system, a firmware, a platform, and an application program (application). As an example embodiment, the application program may be installed or stored in advance in the first display apparatus 100 in manufacturing, or installed in the first display apparatus 100 based data for the application received from the outside in use. The data for the application program may be downloaded to the first display apparatus 100 from an external server, such as, for example, an application market or the like.

As an example embodiment, the controller 205 may determine whether the execution condition for anti-screen burn operation is satisfied while the video wall image is displayed. If the execution condition is satisfied, the controller 205 controls the signal processor 200 to change the video wall image and controls the communicator 203 to transmit the changed video wall image to the adjacent second display apparatus 101. The controller 205 may further control the communicator 203 to transmit, to the second display apparatus 101, an information indicating that the anti-screen burn operation is applied to the changed video wall image.

For example, if a command for executing the anti-screen burn operation is input from the outside, the controller 205 may control the signal processor 200 to change the video wall image, which are displaying, in response to the command. The command for executing the anti-screen burn operation may be received from the user, the image source 10 or the second display apparatus 101.

To prevent and/or reduce a screen burn from occurring in the display 201 of the first display apparatus 100 as the video wall image is displayed for a long time, the user may input the command into the respective display apparatuses 100, 101, 103 and 105 or the first display apparatus 100 to execute the anti-screen burn operation. The command input by the user may include at least one of an operation time for which the anti-screen burn operation is performed with respect to the video wall image, a content needed to change in the video wall image, and a location in the video wall image to which the anti-screen burn operation is applied. The command may be input by directly manipulating each of the plurality of display apparatuses 100, 101, 103 and 105 by the user or using a user command input device, such as a remote control or the like.

The image source 10 may transmit the video wall image to the first display apparatus 100. At the same time, the image source 10 may transmit a command for making the video wall system 1 execute the anti-screen burn operation in a preset cycle to the first display apparatus 100. The first display apparatus 100 may execute the anti-screen burn operation based on the video wall image and the command received from the image source 10.

If it is determined that a first predetermined time has elapsed after the video wall image is displayed, the controller 205 may determine that the execution condition for anti-screen burn operation has been satisfied. Since the screen burn may occur when the same image is displayed for the long time as described above, the controller 205 may perform the anti-screen burn operation if it is determined that the same image has been displayed for the long time.

If it is determined that a second predetermined time has elapsed after at least a portion of the video wall image is displayed in a specific color, based on the image signal, the controller 205 may perform the anti-screen burn operation with respect to the at least a portion of the video wall image.

According to another example embodiment, the video wall system 1 may further include a sensor for sensing the displayed video wall image and receive information from the sensor. The controller 205 may determine whether the at least a portion of the video wall image is still displayed in the specific color even after the second predetermined time has elapsed, based on the information received from the sensor.

According to another example embodiment, the controller 205 may control the communicator 204 to transmit reference information on screen burn. The reference information includes at least one of: information on whether the execution condition for anti-screen burn operation has been satisfied, information on whether the video wall image has been changed, and information on what kind of change the first display apparatus has performed if the video wall image has been changed. For example, if it is determined that the video wall image has been changed based on the received reference information, the second display apparatus 101 does not change the image even if it is determined that the execution condition for anti-screen burn operation has been satisfied. The second display apparatus 101 may change the split individual image or the video wall image within the scope that the changed video wall image is not distorted.

As another example, the controller 205 may control the signal processor 200 to change the split individual image, not the video wall image, and control the communicator 203 to transmit the reference information including information on the changed individual image, to the second display apparatus 101. The second display apparatus 101 may change a split individual image to synchronize with the individual image changed at the first display apparatus 100, based on the received reference information, and display the changed individual image.

According to another example embodiment, the first display apparatus 100 and the second display apparatus 101 may come to different conclusions with respect to whether the execution condition for anti-screen burn operation is satisfied. For example, if the first display apparatus 100 determines that the execution condition for anti-screen burn operation is not satisfied, the first display apparatus 100 does not change the video wall image and transmits the non-changed the video wall image and the reference information on screen burn to the second display apparatus 101. If the second display apparatus 101 determines that the execution condition for anti-screen burn operation is satisfied, the second display apparatus 101 may change the individual image or the video wall image within the scope that the video wall image is not distorted, like changing a color for at least one a portion of the individual, even if the first display apparatus 100 did not change the video wall image, and transmits the video wall image and the reference information on screen burn to the third display apparatus 105.

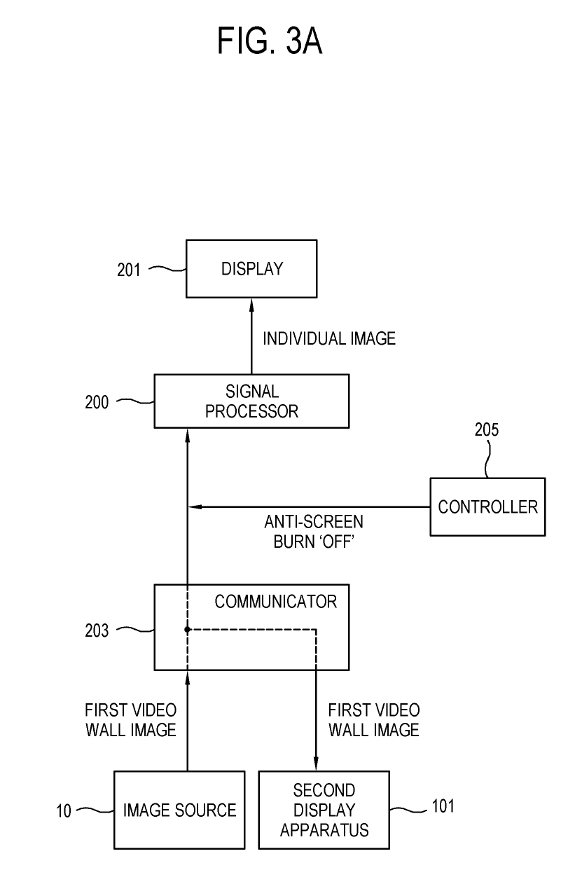

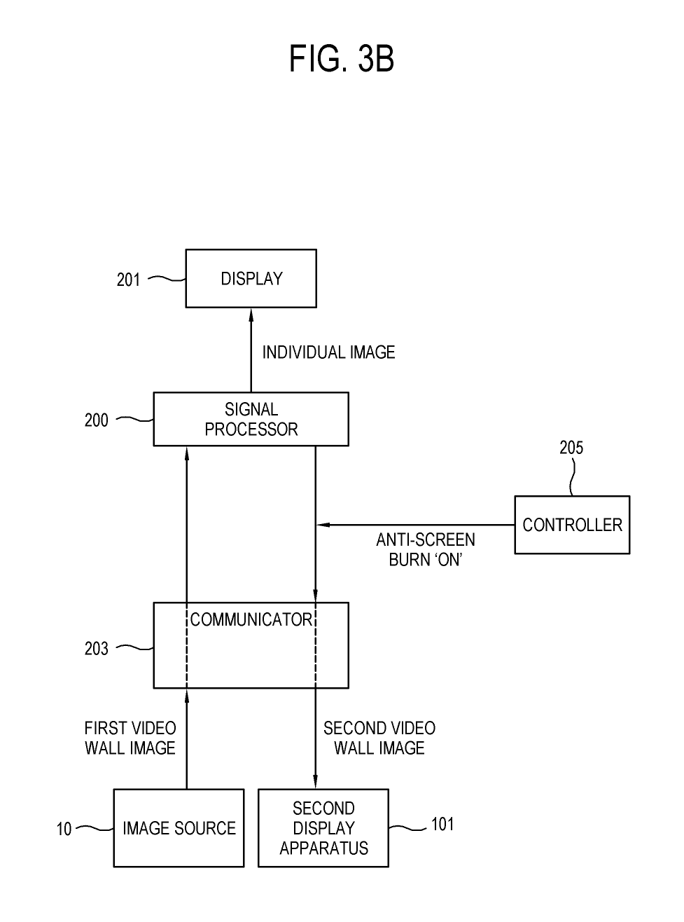

FIGS. 3A and 3B are block diagrams illustrating example operations of the signal processor, the communicator and the controller of the first display apparatus according to an example embodiment. As described above, under the control of the controller 205, the signal processor 200 generates the individual image or changes the video wall image based on the image signal of the video wall image.

FIG. 3A illustrates a process when the anti-screen burn operation is in an ‘OFF’ state. If the execution condition for anti-screen burn operation is not satisfied, when an image signal is received from the outside, the controller 205 controls the signal processor 200 to split a video wall image based on the received image signal with respect to a region corresponding to the first display apparatus 100 thus to generate an individual image for the first display apparatus 100. Also, the controller 205 controls the communicator 203 to transmit the received image signal to the adjacent second display apparatus 101. FIG. 3B illustrates a process when the anti-screen burn operation is in an ‘ON’ state. If the execution condition for anti-screen burn operation is satisfied, when an image signal is received from the outside, the controller 205 controls the signal processor 200 to change a first video wall image based on the received image signal thus to generate a second video wall image and to split the generated second video wall image with respect to the region corresponding to the first display apparatus 100 thus to generate an individual image for the first display apparatus 100. Also, the controller 205 controls the communicator 203 to transmit an image signal of the second video wall image and reference information on screen burn to the adjacent second display apparatus 101. The second display apparatus 101 may perceive that the second video wall image is received, based on the reference information on screen burn, and display an individual image generated in the same method as described above without changing the individual image or change the individual image within the scope that the second video wall image is not distorted and then display the changed individual image.

As another example embodiment, even if the anti-screen burn operation is in the ‘OFF’ state, the first video wall image may be transmitted to the second display apparatus 101 via the communicator 203 after being processed by the signal processor 200 of the first display apparatus 100, as illustrated in FIG. 3B. As further example embodiment, even if the first display apparatus 100 does not change the first video wall image, the first display apparatus 100 may transmit to the second display apparatus 101, reference information on screen burn informing that the first video wall image is not changed along with the first video wall image. The second display apparatus 101 perceives that the first video wall image is not changed, based on the received reference information and splits the non-changed video wall image to display an individual image therefor. Even if the first display apparatus 100 does not change the first video wall image, the second display apparatus 101 may change the non-changed first video wall image to generate a second video wall image or change a split individual image, within the scope that the first video wall image is not distorted if it is determined that the execution condition for anti-screen burn operation has been satisfied.

As another example embodiment, when the anti-screen burn operation is in the ‘ON’ state, the first display apparatus 100 may not change the first video wall image and display changing an individual image split from the first video wall image. The first display apparatus 100 may transmit to the second display apparatus 101, reference information on screen burn informing that the first video wall image has not been changed, but the individual image has been changed.

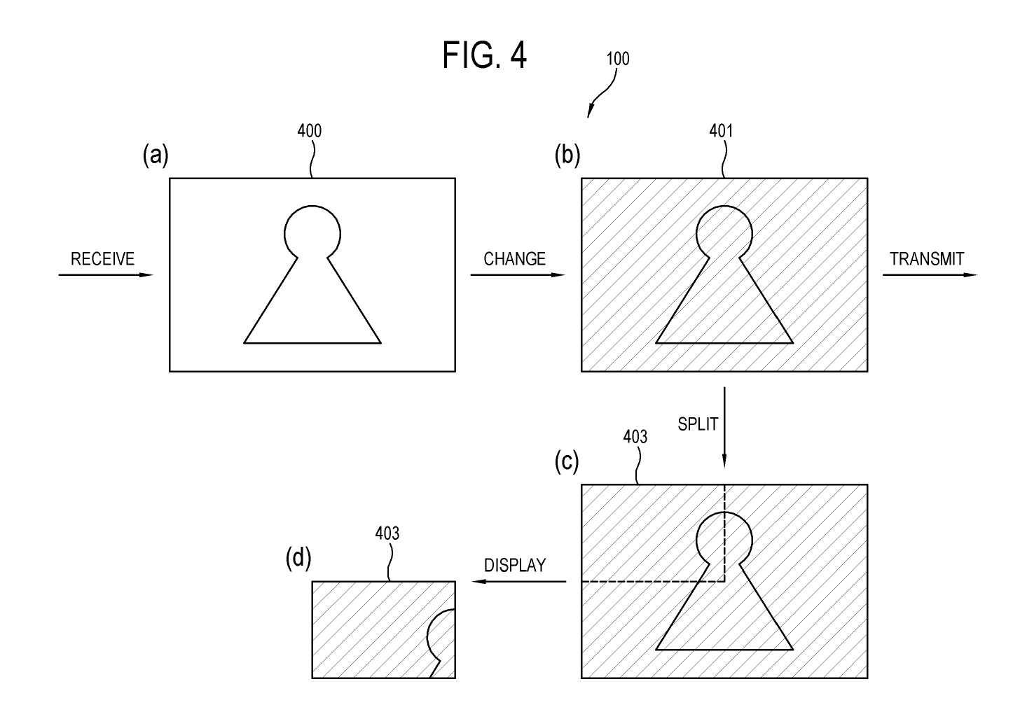

FIG. 4 is a diagram illustrating an example of an operation of the first display apparatus according to an example embodiment.

In FIG. 4, (a) is an example of a first video wall image 400 received by the first display apparatus. If the first video wall image 400 is received, the first display apparatus 100 determines whether the execution condition for anti-screen burn operation has been satisfied. If the execution condition has been satisfied, the first display apparatus 100 changes the first video wall image 400 to generate a second video wall image 401.

In FIG. 4, (b) is an example of the second video wall image 401 changed from the first video wall image 400. The first display apparatus 100 transmits the second video wall image 401 and reference information on screen burn to the adjacent second display apparatus 101. The second video wall image 401 as illustrated in FIG. 4 is shown as being merely hatched for convenience, but an actually anti burn-processed image may appear different therefrom. In other words, the second video wall image 401 according to an example embodiment may be an image in which the first video wall image 400 is shifted by a predetermined number of pixels, or an image in which the first video wall image 400 is changed in brightness or color. The idea of the disclosure is not limited thereto. To prevent and/or reduce the screen burn, the first display apparatus 100 may change the first video wall image 400 in various methods.

In FIG. 4, (c) is an example of splitting the second video wall image 401 with respect to a region corresponding to the first display apparatus 100 to generate an individual image 403 therefor as illustrated in (d) of FIG. 4. The first display apparatus 100 transmits the changed second video wall image 401 to the second display apparatus 101, and generates the individual image 403 by splitting the changed second video wall image 401 with respect to the region corresponding to the first display apparatus 100.

In FIG. 4, (d) is an example of displaying the individual image 403 generated by splitting the changed second video wall image 401 with respect to the region corresponding to the first display apparatus 100, at the first display apparatus 100.

If the anti-screen burn operation is in the ‘OFF” state, the first display apparatus 100 transmits the received first video wall image 400 to the second display apparatus 101, and displays an individual image generated by splitting the first video wall image 400 with respect to the region corresponding to the first display apparatus 100.

As a further example embodiment, when the anti-screen burn operation is in the ‘OFF” state, the display apparatus 100 may transmit to the second display apparatus 10, reference information on screen burn informing that the first video wall image 400 is an non-changed image with the first video wall image 400.

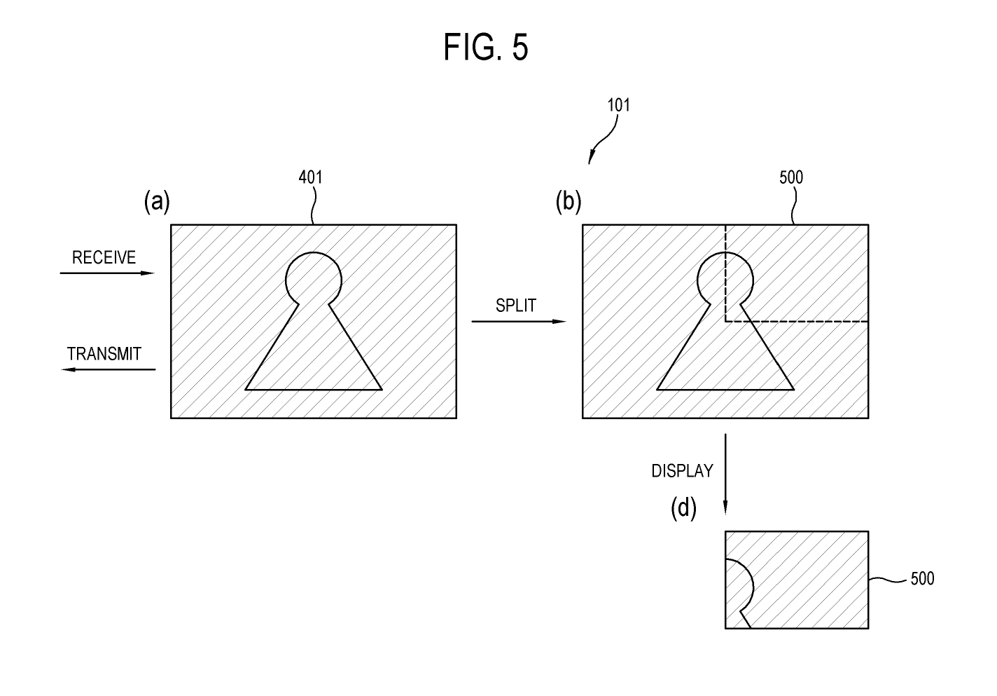

FIG. 5 is a diagram illustrating an example of an operation of the second display apparatus of the video wall system according to an example embodiment.

In FIG. 5, (a) is an example of a second video wall image 401 received by the second display apparatus 101. The second display apparatus 101 receives the second video wall image 401 changed and generated by the first display apparatus 100. The second display apparatus 101 may receive reference information on screen burn with the second video wall image 401 from the first display apparatus 100. The second display apparatus 101 transmits the received second video wall image 401 to the adjacent third display apparatus 103.

In FIG. 5, (b) is an example of splitting the second video wall image 401 with respect to a region corresponding to the second display apparatus 101 to generate an individual image 500 therefor. The second display apparatus 101 generates the individual image 500 by splitting the second video wall image 401 with respect to the region corresponding to the second display apparatus 101.

In FIG. 5, (c) is an example of displaying the individual image 500 generated by splitting the second video wall image 401 with respect to the region corresponding to the second display apparatus 101, at the second display apparatus 101.

As another example embodiment, the second display apparatus 101 may operate based on the reference information on screen burn received with the first video wall image 400 or the second video wall image 401. For example, the second display apparatus 101 may split the individual image 500 from the second video wall image 401 based on the reference information on screen burn, and display the split individual image 500 or change the split individual image 500 in the scope that the second video wall image 401 is not distorted and then display the changed individual image.

As further example embodiment, the second display apparatus 101 may change the second video wall image 401 in the scope that the second video wall image 401 is not distorted to generate a third video wall image, transmit the third video wall image to the third display apparatus 103, and split the third video wall image to display an individual image therefor.

As another example embodiment, the second display apparatus 101 may determine that the first video wall image 400 has not been changed, based the reference information on screen burn, split the individual image 500 from the first video wall image 400, and display the split individual image 500 or change the split individual image 500 within the scope that the first video wall image 400 is not distorted and then display the changed individual image.

As another example embodiment, the second display apparatus 101 may change the first video wall image 400 in the scope that the first video wall image 400 is not distorted to generate a fourth video wall image, transmit the fourth video wall image to the third display apparatus 103, and split the fourth video wall image to display a split individual image.

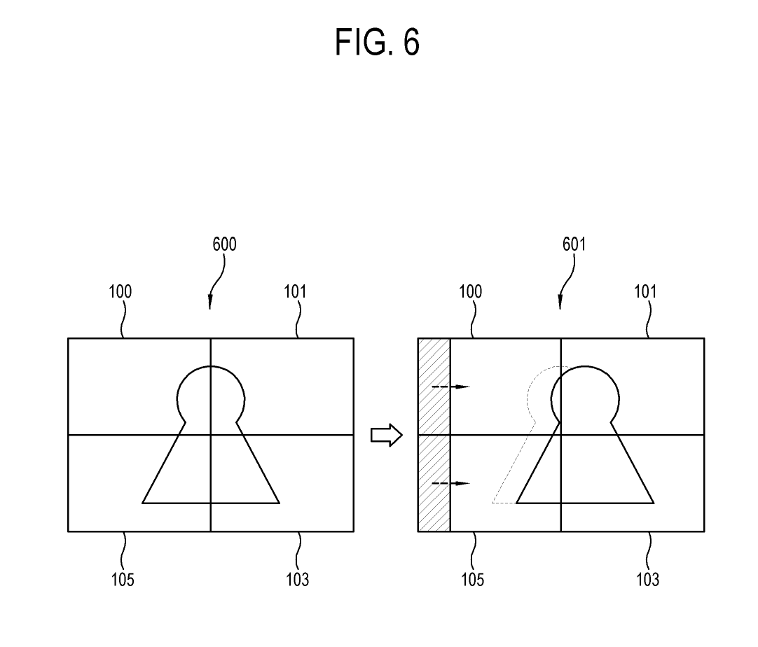

Hereinafter, an anti-screen burn operation, which is performed by the video wall system 1 according to an example embodiment, will be described in greater detail. Referring to FIG. 6, an example of displaying a second video wall image 601 in which a first video wall image 600 is shifted by a predetermined number of pixels to prevent and/or reduce a screen burn from generating while the first video wall image 600 is displayed is illustrated. As an example embodiment, to prevent and/or reduce the screen burn, the first display apparatus 100 may shift the first video wall image 600.

The screen burn is a phenomenon in which, for example, phosphors or light-emitting pixels are degraded when displaying the same color for a long time. To prevent and/or reduce the screen burn, the first display apparatus 100 may gradually move a screen, which is displaying, in a given direction, thereby forcibly changing colors displayed by respective pixels. As an example, the first display apparatus 100 may shift the first video wall image 600, which is displaying, by one pixel per minute in one direction, and if the first video wall image 600 is moved by ten pixels, shift the first video wall image 600 by one pixel per minute in a direction opposite to the one direction. Thus, the second video wall image 601 may be generated.

The respective display apparatuses 100, 101, 103, and 105 split the shifted second video wall image 601 with respect to regions corresponding thereto and display split individual images, respectively. The shifting is not limited to the drawing and the explanations described above. The first video wall image 600 may be shifted according to various implementation examples without being limiting to the shifted extent or the direction as illustrated in the drawing.

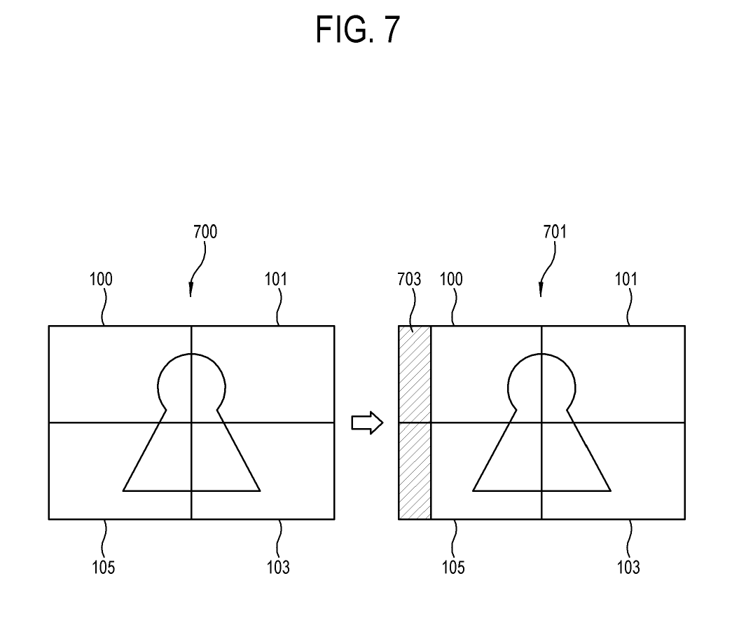

FIG. 7 is a diagram illustrating an example of inserting a replacement image 703 into a portion of a first video wall image 700 to generate a second video wall image 701. As an example embodiment, to prevent and/or reduce the screen burn, the first display apparatus 100 may insert the replacement image 703 into at least a portion of the first video wall image 700. If it is determined that the portion of the first video wall image 700 is displayed in the same color for a predetermined time, the first display apparatus 100 may insert the replacement image 703 into the portion of the first video wall image 700 to generate the second video wall image 701. The inserted replacement image 703 may be gradually moved in a given direction, thereby forcibly changing colors displayed by respective pixels. The idea of the disclosure is not limited to the example illustrated in FIG. 7. For example, replacement images, which are implemented in various types to prevent and/or reduce the screen burn, may be freely inserted into at least a portion of the first video wall image displayed in the same color for more than a predetermined time or a portion of the first video wall image selected by the user.

As another example embodiment, to prevent and/or reduce the screen burn, the first display apparatus 100 may change a color of a first video wall image (400 in FIG. 4). The color of the first video wall image 400 may be gradually changed until it is changed by a predetermined level. The respective display apparatuses 100, 101, 103, and 105 split a second video wall image (401 in FIG. 4), color of which is changed, with respect to regions corresponding thereto and display split individual images, respectively. According to another example embodiment, the first display apparatus 100 may change the color of only a selected portion in the first video wall image 400.

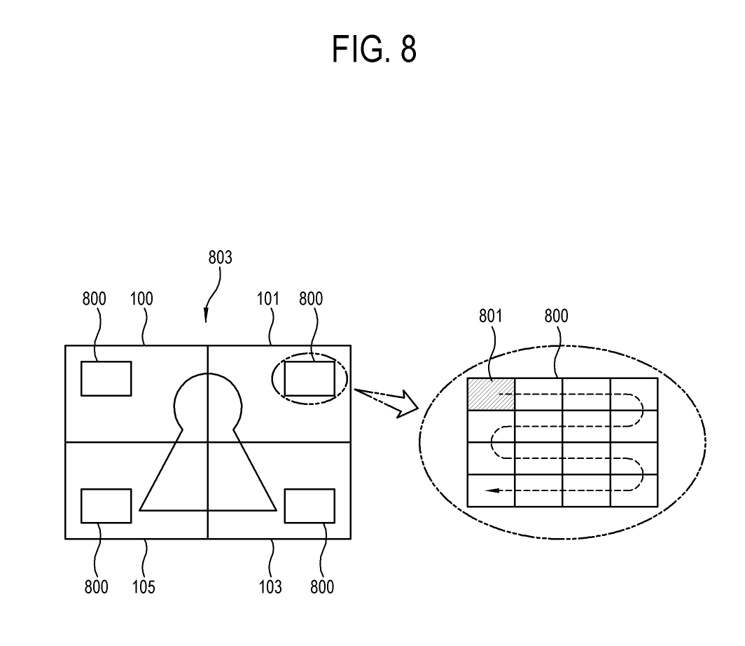

FIG. 8 is a diagram illustrating a further example of selecting at least one region 800 in a first video wall image 803 and changing a color of pixels in the selected at least one region 800. According to an example embodiment, to prevent and/or reduce a screen burn for some portions of the first video wall image 803, the first display apparatus 100 may perform an anti-screen burn operation with respect to some regions corresponding to the portions of the first video wall image 803. As a non-limiting example, the anti-screen burn operation, which is performed according to regions, includes at least one of changing the color by regions, inserting a replacement image by regions and shifting the first video wall image by regions.

According to user's selection or displaying some regions 800 in the same color for a predetermined time or more, the first display apparatus 100 selects the regions 800 in the first video wall image 803. The first display apparatus 100 changes the color of at least one pixel in the selected regions 800 into another color. The color change may be performed gradually moving pixels 801 in the selected regions 800 as illustrated in FIG. 8, thereby preventing and/or reducing the screen burn for the selected regions 800. Since the drawing and explanations thereon as described above are merely an example for the convenience of explanation, the idea of the disclosure is not limited to the method to prevent and/or reduce the screen burn in the regions 800, the type and the number of the regions 800, and the like, as illustrated in FIG. 8.

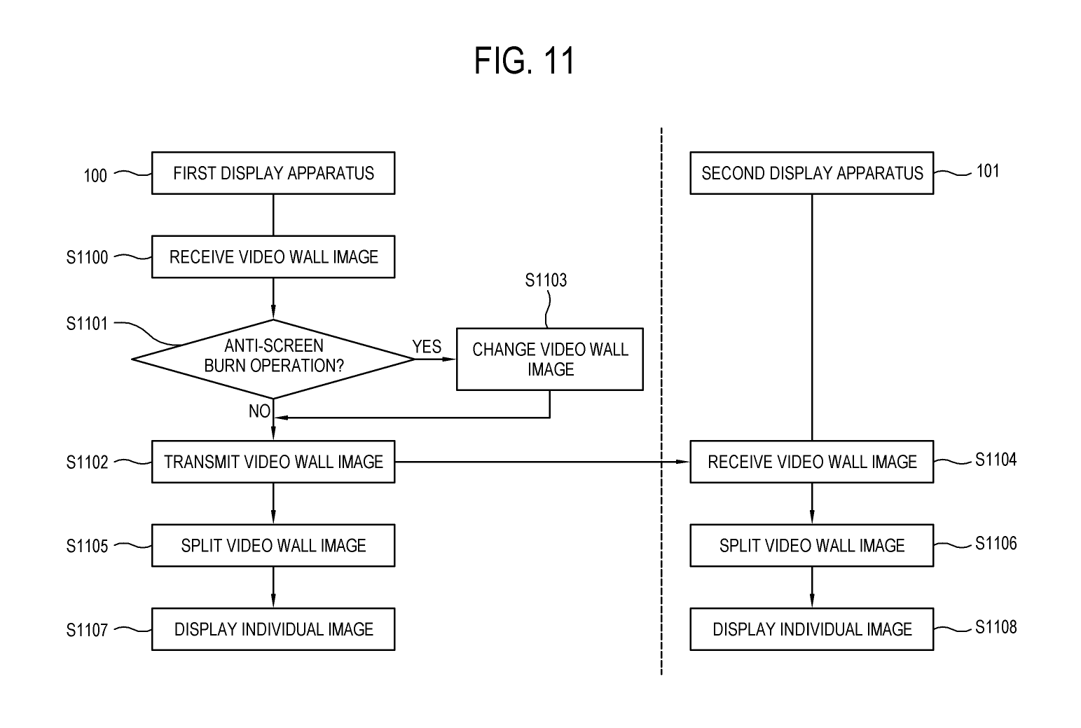

FIG. 11 is a flowchart illustrating an example control method of the video wall system according to an example embodiment.

At an operation S1100, the first display apparatus 100 receives a video wall image. As described above, the video wall image may be received from the external image source 10 or via receiving a broadcast signal transmitted from the broadcasting station. Also, the first display apparatus 100 may bring in a stored video wall image.

At an operation S1101, the first display apparatus 100 determines whether an execution condition for anti-screen burn operation has been satisfied. If the execution condition has been satisfied, at an operation S1103, the first display apparatus 100 changes the video wall image. The change of the video wall image may be implemented by various example embodiments, such as, for example, and without limitation, the image shift, the partial deletion of image, the replacement image insertion, the color change and the like.

If the execution condition has not been satisfied, at an operation S1102, the first display apparatus 100 transmits the non-changed video wall image. If the video wall image has been already changed at the operation S1103, at the operation S1102, the first display apparatus 100 transmits the changed video wall image.

At an operation S1105, the first display apparatus 100 splits the changed or non-changed video wall image with respect to a region corresponding to the first display apparatus 100, and at an operation S1107, displays a split individual image.

At an operation S1104, the second display apparatus 101 receives the changed or non-changed video wall image from the first display apparatus 100. At operation S1106, the second display apparatus 101 splits the changed or non-changed video wall image with respect to a region corresponding to the second display apparatus 101, and at an operation S1108, displays a split individual image.

While various example embodiments have been illustrated and described, it will be understood by those skilled in the art that various changes in form and details may be made therein without departing from the spirit and scope of the present disclosure as defined by the appended claims and their equivalents.

What is claimed is:

1. A video wall system comprising:
a first display apparatus and a second display apparatus configured to display a video wall image,
wherein the first display apparatus is configured:
to display a first individual image, the first individual image being corresponding to a first area of a first video wall image, and to transmit the first video wall image to the second display apparatus; and
in response to an execution condition for anti-screen burn operation being satisfied while the first individual image is displayed,
to generate a second video wall image by changing the first video wall image,
to display a second individual image, the second individual image being corresponding to the first area of the generated second video wall image, and
to transmit the generated second video wall image to the second display apparatus, and
wherein the second display apparatus is configured to display a third individual image, the third individual image being corresponding to a second area of one video wall image of the first video wall image and the second video wall image received from the first display apparatus, the second area being different from the first area.

2. The system according to claim 1, wherein the execution condition is satisfied by at least one of: when a command for executing the anti-screen burn operation is input, when a first time elapses after the first video wall image is displayed, and when a second time elapses after at least a portion of the first video wall image is displayed in a specific color.

3. The system according to claim 1, wherein the changing of the first video wall image comprises at least one of: shifting the first video wall image by a predetermined number of pixels, deleting at least a portion of the first video wall image, inserting a replacement image into at least a portion of the first video wall image, and changing a color of at least a portion of the first video wall image.

4. The system according to claim 1, wherein each of the first and the second display apparatuses comprises a display panel comprising OLED elements.

5. The system according to claim 1, wherein the first display apparatus is configured to receive the first video wall image from an external apparatus.

6. The system according to claim 1, further comprising:
a third display apparatus configured to receive one of the first video wall image and the second video wall image from the first display apparatus.

7. The system according to claim 1, further comprising:
a third display apparatus configured to receive a video wall image from the second display apparatus, the video wall image being transmitted by the first display apparatus and being one of the first video wall image and the second video wall image.

8. A method of controlling a video wall system, the video wall system comprising a first display apparatus and a second display apparatus configured to display a video wall image, the method comprising:
displaying, by the first display apparatus, a first individual image, the first individual image being corresponding to a first area of a first video wall image,
transmitting, by the first display apparatus, the first video wall image to the second display apparatus;
in response to an execution condition for anti-screen burn operation being satisfied while the first individual image is displayed,
generating, by the first display apparatus, a second video wall image by changing the first video wall image,
displaying, by the first display apparatus, a second individual image, the second individual image being corresponding to the first area of the generated second video wall image,
transmitting, by the first display apparatus, the generated second video wall image to the second display apparatus; and
displaying, by the second display apparatus, a third individual image, the third individual image being corresponding to a second area of one video wall image of the first video wall image and the second video wall image received from the first display apparatus, the second area being different from the first area.

9. The method according to claim 8, wherein the execution condition is satisfied by at least one of: when a command for executing the anti-screen burn operation is input, when a first time elapses after the first video wall image is displayed, and when a second time elapses after at least a portion of the first video wall image is displayed in a specific color.

10. The method according to claim 8, wherein the changing of the first video wall image comprises at least one of: shifting the first video wall image by a predetermined number of pixels, deleting at least a portion of the first video wall image, inserting a replacement image into at least a portion of the first video wall image, and changing a color of at least a portion of the first video wall image.

11. The method according to claim 8, wherein each of the first and the second display apparatuses comprises a display panel comprising OLED elements.

12. The method according to claim 8, further comprising:
receiving, by the first display apparatus, the first video wall image from an external apparatus.

13. The method according to claim 8, further comprising:
receiving, by a third display apparatus, one of the first video wall image and the second video wall image from the first display apparatus,
wherein the video wall system further comprises the third display apparatus.

14. The method according to claim 8, further comprising:
receiving, by a third display apparatus, a video wall image from the second display apparatus, the video wall image being transmitted by the first display apparatus and being one of the first video wall image and the second video wall image,
wherein the video wall system further comprises the third display apparatus.

15. A display apparatus of a video wall system configured to display a video wall image, comprising:
a signal processor configured to process an image signal;
a display configured to display an image;
a communicator comprising communication circuitry configured to communicate with an external display apparatus; and
a controller configured:
to control the signal processor, in response to an execution condition for anti-screen burn operation being satisfied while a first individual image is displayed,
to generate a second video wall image by changing a first video wall image,
to split the generated second video wall image with respect to a first area to generate a second individual image,
to control the display to display the second individual image, and
to control the communicator to transmit the generated second video wall image to the external display apparatus.

16. The system according to claim 1, wherein the first display apparatus is further configured:
in response to the execution condition for anti-screen burn operation being satisfied while the first individual image is displayed, to transmit, to the second display apparatus, an information indicating that the anti-screen burn operation is applied to the second video wall image.

17. The method according to claim 8, further comprising:
in response to the execution condition for anti-screen burn operation being satisfied while the first individual image is displayed, transmitting, to the second display apparatus, an information indicating that the anti-screen burn operation is applied to the second video wall image.

18. The display apparatus according to claim 15,
the controller is further configured:
in response to the execution condition for anti-screen burn operation being satisfied while the first individual image is displayed, to transmit, to the second display apparatus, an information indicating that the anti-screen burn operation is applied to the second video wall image.
